(19) United States
(12) Patent Application Publication
(10) Pub. No.: US 2026/0342401 A1
(43) Pub. Date: Oct. 29, 2026

(54) W2 Design for CSI Prediction

(71) Applicant: Apple Inc., Cupertino, CA (US)

(72) Inventors: Haitong SUN, Saratoga, CA (US); Chunxuan YE, San Diego, CA (US); Dawei ZHANG, Saratoga, CA (US); Hong HE, San Jose, CA (US); Huaning NIU, San Jose, CA (US); Jie CUI, San Jose, CA (US); Wei ZENG, Saratoga, CA (US)

(21) Appl. No.: 19/483,763

(22) PCT Filed: May 10, 2024
(86) PCT No.: PCT/US2024/028881

§ 371 Date: Nov. 12, 2025

Related U.S. Application Data
(60) Provisional application No. 63/501,438, filed on May 11, 2023.

(51) Int. Cl. H04B 7/06

(52) U.S. Cl. CPC H04B 7/0626

(57) ABSTRACT

An apparatus comprising configured to process, based on signals received from a base station, channel state information (CSI) configuration information for reporting type II codebook based CSI feedback in a CSI report, the CSI configuration information including a maximum number of non-zero coefficients (NZC) in W₂ to include in the CSI report, process, based on signals received from the base station, a message comprising CSI measurement resources and generate, for transmission to the base station, the type II codebook CSI feedback.

### PRIORITY/INCORPORATION BY REFERENCE

This application claims priority to U.S. Provisional Application Ser. No. 63/501,438 entitled “W2 Design for CSI Prediction,” filed on May 11, 2023, the entirety of which is incorporated by reference herein.

### BACKGROUND

A user equipment (UE) may connect to a fifth generation (5G) new radio (NR) network. In certain types of deployment scenarios, it has been identified that conventional channel state information (CSI) reporting mechanisms may quickly become outdated due to the amount of time that passes between when the channel is measured by a user equipment (UE) and when the CSI report is received by the network. To enhance the CSI framework for 5G NR, CSI prediction can be supported wherein a time basis is introduced into the Type II codebook structure.

### SUMMARY

Some example embodiments are related to an apparatus having processing circuitry configured to process, based on signals received from a base station, channel state information (CSI) configuration information for reporting type II codebook based CSI feedback in a CSI report, the CSI configuration information including a maximum number of non-zero coefficients (NZC) in W₂ to include in the CSI report, process, based on signals received from the base station, a message comprising CSI measurement resources and generate, for transmission to the base station, the type II codebook CSI feedback.

Other example embodiments are related to an apparatus having processing circuitry configured to process, based on signals received from a base station, channel state information (CSI) configuration information for reporting type II codebook based CSI feedback in a CSI report, process, based on signals received from the base station, a message comprising CSI measurement resources, determine a priority for multiple non-zero coefficients (NZC) in W₂ to include in the CSI report and generate, for transmission to the base station, the type II codebook CSI feedback.

Still further example embodiments are related to an apparatus having processing circuitry configured to process, based on signals received from a base station, channel state information (CSI) configuration information for reporting type II codebook based CSI feedback in a CSI report, process, based on signals received from the base station, a message comprising CSI measurement resources, select, from among multiple non-zero coefficients (NZC) in W₂, a reference NZC, quantize the NZC and generate, for transmission to the base station, the type II codebook CSI feedback.

### BRIEF DESCRIPTION OF THE DRAWINGS

FIG. 1 shows an example network arrangement according to various example embodiments.

FIG. 2 shows an example user equipment (UE) according to various example embodiments.

FIG. 3 shows an example base station according to various example embodiments.

FIG. 4 shows a signaling diagram for reporting CSI feedback according to various example embodiments.

FIG. 5 shows a timing diagram demonstrating the delay between the transmission of a reference signal and the reporting of CSI based on the reference signal according to current CSI mechanisms.

FIG. 6 shows a timing diagram including parameters relevant to CSI prediction according to various example embodiments.

FIG. 7 shows a method for reporting non-zero coefficients (NZC) in W₂ in a CSI report according to various example embodiments.

### DETAILED DESCRIPTION

The example embodiments may be further understood with reference to the following description and the related appended drawings, wherein like elements are provided with the same reference numerals. The example embodiments introduce channel state information (CSI) reporting enhancements.

The example embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any electronic component.

The example embodiments are also described with regard to a fifth generation (5G) New Radio (NR) network configured with type-II codebook based CSI feedback. However, reference to a 5G NR network is merely provided for illustrative purposes. The example embodiments may be utilized with any appropriate type of network and/or codebook.

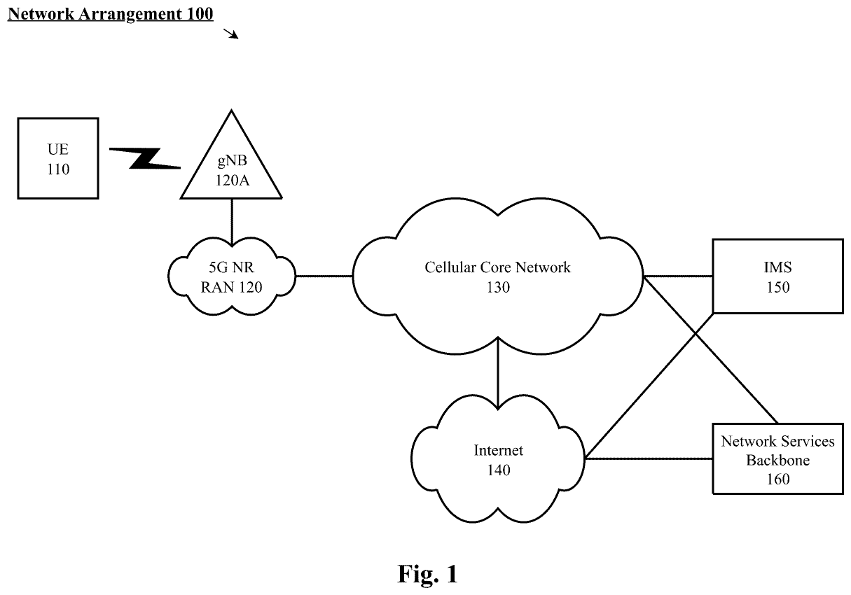

FIG. 1 shows an example network arrangement 100 according to various example embodiments. The example network arrangement 100 includes a UE 110. The UE 110 may be any type of electronic component that is configured to communicate via a network, e.g., mobile phones, tablet computers, desktop computers, smartphones, phablets, embedded devices, wearables, Internet of Things (IoT) devices, etc. An actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the example embodiments, the UE 110 may establish a connection with the 5G NR RAN 120. Therefore, the UE 110 may have a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific base station, e.g., the gNB 120A.

The network arrangement 100 also includes a cellular core network 130, the Internet 140, an IP Multimedia Subsystem (IMS) 150, and a network services backbone 160. The cellular core network 130 may refer an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

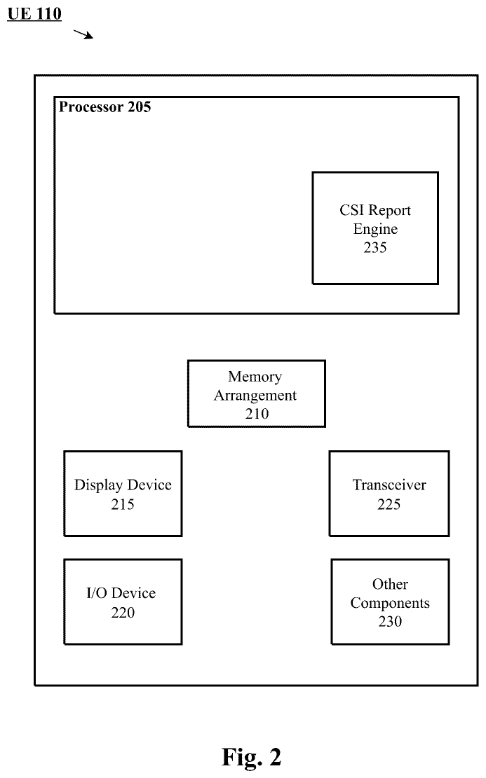

FIG. 2 shows an example UE 110 according to various example embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a CSI report engine 235. The CSI report engine 235 may perform various operations related to reporting CSI including, but not limited to, receiving CSI measurement resources, generating a CSI report and transmitting the CSI report to the network.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

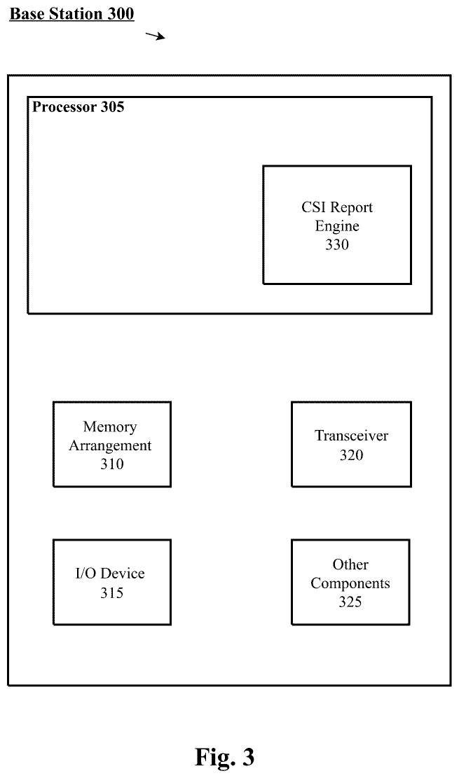

FIG. 3 shows an example base station 300 according to various example embodiments. The base station 300 may represent the gNB 120A or any other access node through which the UE 110 may establish a connection and manage network operations.

The base station 300 may include a processor 305, a memory arrangement 310, an input/output (I/O) device 315, a transceiver 320 and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines for the base station 300. For example, the engines may include a CSI report engine 330. The CSI report engine 330 may perform various operations related to CSI reporting including, but not limited to, transmitting CSI configuration information, transmitting CSI measurement resources and receiving a CSI report.

The above noted engine 330 being an application (e.g., a program) executed by the processor 305 is only an example. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The example embodiments may be implemented in any of these or other configurations of a base station.

The memory 310 may be a hardware component configured to store data related to operations performed by the base station 300. The I/O device 315 may be a hardware component or ports that enable a user to interact with the base station 300.

The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

In 5G NR, a type-II multiple input multiple output (MIMO) codebook may be based on a W₁*W₂*W_{f}, where W₁ represents a spatial basis selection, W_{f} represents a frequency basis selection and W₂ represents a linear combination coefficient. The type-II codebook may utilize the channel spatial domain properties W₁ and the frequency domain properties W_{f} to construct the CSI efficiently.

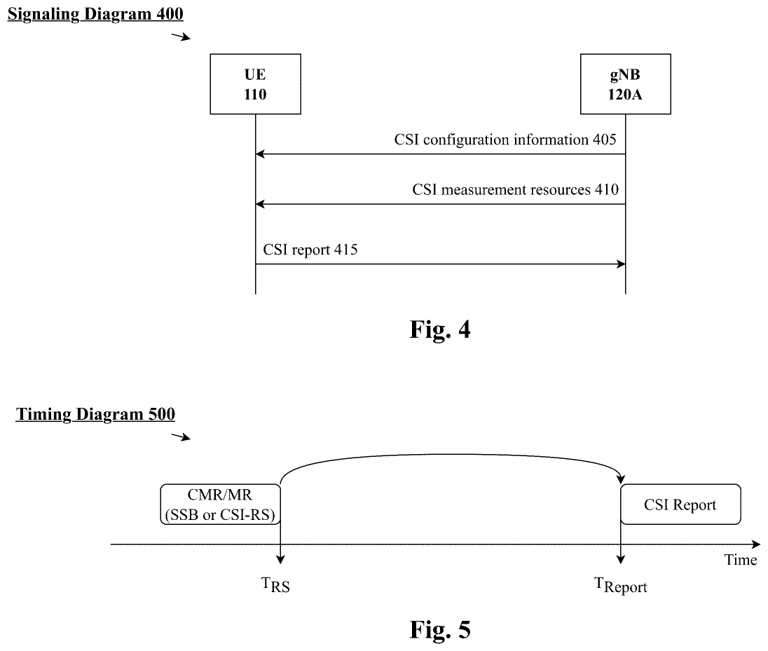

FIG. 4 shows a signaling diagram 400 for reporting CSI feedback according to various example embodiments. The signaling diagram 400 is described with regard to the network arrangement 100 of FIG. 1, the UE 110 of FIG. 2 and the base station 300 of FIG. 3.

The signaling diagram 400 is described with regard to a scenario in which the UE 110 reports CSI feedback to the gNB 120A. Initially, a general overview of this example scenario is described below to provide context for the example CSI reporting techniques introduced herein. The example embodiments include enhancements for constructing the CSI report with non-zero coefficients (NZC) in the W₂ term of the type-II codebook when a time/Doppler basis W_{d} is introduced into the type-II codebook structure and will be described in greater detail below.

In 405, the UE 110 receives CSI configuration information from the gNB 120A. The configuration information may include, but is not limited to, configuration information for CSI measurement resources, the type of CSI to be reported and CSI reporting parameters. An aperiodic CSI report can be configured and associated with an index value that can be carried in DCI to trigger the CSI report.

The CSI configuration information may be provided to the UE 110 in one or more Radio Resource Control (RRC) messages. For example, the RRC messages may include information element (IEs) such as, but not limited to, CSI-ResourceConfig, CSI-ReportConfig, reportQuantity and codebookConfig. However, the example embodiments are not limited to RRC messages, and CSI configuration information may be provided in any appropriate type of message (e.g., medium access control (MAC) control element (CE), downlink control information (DCI), etc.).

The CSI configuration information may include configuration information for the CSI measurement resources. The CSI measurement resources may be provided using synchronization signal block (SSB), CSI-reference signal (RS) or any other appropriate type of signal. The CSI measurement resources may include channel measurement resources (CMR) such as, e.g., one or more non-zero power (NZP) CSI-reference signals (RS).

The UE 110 may be configured with one or more sets of CSI measurement resources. Each set of CSI measurement resources may include one or more CMRs. The network may configure the sets of CSI measurement resources using the CSI configuration information provided in 405 or any other appropriate message. In some embodiments, the network may selectively activate or deactivate a set of configured CSI measurement resources at the UE 110 using a MAC CE, DCI or any other appropriate type of message.

In 410, the UE 110 receives CSI measurement resources. In the signaling diagram 400, the CSI measurement resources are transmitted by the gNB 120A. However, in an actual deployment scenario, the UE 110 may receive CSI measurement resources from multiple serving cells including serving cells deployed by a gNB or base station other than the gNB 120A.

In 415, the UE 110 transmits a CSI report to the gNB 120A. The contents of the CSI report and the transmission of the CSI report may be based on the CSI configuration information provided by the gNB 120A in 405. For example, the network may configure the UE 110 with CSI measurement resources using the CSI-ResourceConfig IE. A CSI report may include one or more different types of CSI (e.g., PMI, COI, RI, LI, etc.) derived based on CSI measurement resources. The network may specify the type of CSI to be reported using the reportQuantity IE configured to indicate which one or more parameters are to be reported. The example embodiments introduced below may be utilized in conjunction with any appropriate currently implemented CSI reporting mechanisms or future implementations of a CSI reporting mechanism or independently from other CSI reporting mechanisms.

Alternatively, or in addition to RRC messages, CSI configuration information may be provided in a MAC CE, DCI or any other appropriate type of signal. For example, a MAC CE and/or DCI may be configured to activate and deactivate sets of CSI measurement resources, indicate a CSI report periodicity and slot offset, indicate a codebook type, change a configuration of a CSI parameter previously configured by an RRC message or provide any other type of configuration information relevant to reporting CSI.

As described above, according to current specifications, a type-II MIMO codebook may be based on a W₁*W₂*W_{f} structure where W₁ represents a spatial basis, W_{f} represents a frequency basis and W₂ represents a linear combination coefficient matrix. Each of these matrices (W₁, W₂, W) are defined in various 3GPP standards and documents. In this description, these matrices may be used in the manner in which they are defined in the 3GPP standards and documents and may be modified in accordance with the example embodiments described herein.

According to current specification, a CSI report may include one or more PMIs. Each PMI may explicitly or implicitly indicate a UE 110 preferred precoder based on the type II codebook structure (W₁*W₂*W_{f}) described above. For example, the PMI may include a spatial component corresponding to the spatial basis of the UE preferred precoder (e.g., W₁), a frequency component corresponding to the frequency basis the UE preferred precoder (e.g., W_{f}) and a linear combination coefficient component corresponding to the combination coefficient of the UE preferred precoder (e.g., W₂). Each component of the PMI may be associated with one or more parameters that are identified by a codebook index hard encoded in the 3GPP Specifications. There are various different types of codebook indices mapped to a variety of different formulas and tables in the 3GPP Specifications. In this description, these codebook indices may be used in the manner in which they are defined in the 3GPP Specifications and may be modified in accordance with the example embodiments described herein. However, the example embodiments are not limited to utilizing the parameters referenced above and may utilize any appropriate type of information to indicate a preferred precoder to the network.

Currently, NR does not support CSI prediction. The UE measures CSI based on the reference signal transmitted at T_{RS}, and reports CSI at a future time Tᵣₑₚₒᵣₜ. The reported CSI only represents the channel observed in the past at T_{RS}. There is a known CSI aging issue where the reported CSI becomes outdated. For example, a channel may be changing rapidly and the CSI report at time Tᵣₑₚₒᵣₜ may not represent the channel observed at time T_{RS}.

FIG. 5 shows a timing diagram 500 demonstrating the delay between the transmission of a reference signal and the reporting of CSI based on the reference signal according to current CSI mechanisms. Measurement resources, e.g., channel measurement resources (CMR) and/or interference measurement resources (IMR), are transmitted at time T_{RS}. The UE can perform channel measurements for the measurement resources and process these measurements to, e.g., build the CSI report. The CSI report is transmitted after this measurement/processing delay at time Tᵣₑₚₒᵣₜ.

For Rel-18 NR MIMO evolution, it was agreed to support UE-side CSI prediction by Type II codebook enhancement with codebook structure W₁·W₂·(W_{f}⊗W_{d})^{H}, where W₁ is the spatial basis selection matrix; W_{f} is the frequency basis selection matrix; W_{d} is the time/Doppler basis selection matrix; and W₂ is the linear combination coefficient matrix. The W_{d} term is newly introduced for CSI prediction. The W₂ term can be based on PMI reporting components related to the spatial basis, the frequency basis and the time/Doppler basis.

The network can explicitly configure, or the UE can implicitly determine from the network configuration, the following parameters related to CSI prediction: m is the offset between two adjacent AP-CSI-RS resources for the CMR in slots; K is the number of AP-CSI-RS resources for the CMR; δ is the number of slots from the CSI report slot to the first predicted CSI; N₄ is the number of predicted CSI; d is the distance between two predicted CSI in slots.

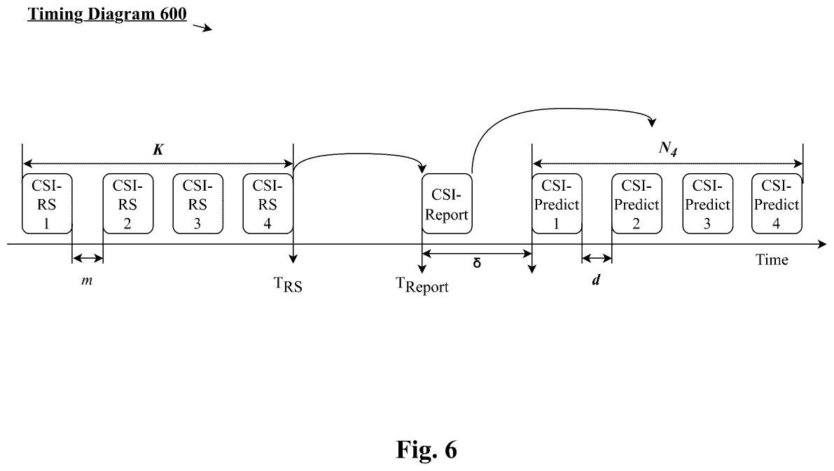

FIG. 6 shows a timing diagram 600 including parameters relevant to CSI prediction according to various example embodiments. These parameters include the offset m, the number of AP-CSI-RS resources K, the number of slots δ from the CSI report slot to the first predicted CSI, the number N₄ of predicted CSI, and the distance d between two predicted CSI. In this example, K=4 and N₄=4. Thus, the UE can measure the AP-CSI-RS resources, observe changes in the channel measurements over time, and predict channel conditions later in time. The UE can provide CSI measurement predictions for a number of later times.

The term “PMI reporting component” may generally refer to information provided in a CSI report that may be used to derive the UE preferred precoder. In some examples, reference is made to a “spatial basis PMI reporting component” which refers to information provided in a CSI report that may be used to derive a spatial basis of the UE preferred precoder (e.g., W₁); a “frequency basis PMI” which refers to information provided in a CSI report that may be used to derive a frequency basis of the UE preferred precoder (e.g., W_{f}); a “time/Doppler basis PMI” which refers to information provided in a CSI report that may be used to derive a time/Doppler basis of the UE preferred precoder (e.g., W_{d}); or a “combination coefficient PMI reporting component” which refers to information provided in a CSI report that may be used to derive the combination coefficient the UE preferred precoder (e.g., W₂). Each of the PMI reporting components identified above may be associated with one or more parameters identified by a codebook index and/or any other appropriate type of information that may be used to derive the UE preferred precoder. A CSI report may be configured with a maximum number of bits that may be allocated to PMI reporting components and/or the CSI report as a whole.

Each of the spatial basis PMI reporting component, the frequency basis PMI reporting component, the time/Doppler basis PMI reporting component, and the combination coefficient PMI reporting component may be based on multiple parameters that each associated with a codebook index value. The following list provides some specific, non-limiting examples, of PMI related parameters that belong to one or more of the spatial basis PMI reporting component (W₁), the frequency basis PMI reporting component (W_{f}), the time/Doppler basis PMI reporting component (W_{d}) and the linear combination coefficient PMI reporting component (W₂): rotation factor for spatial basis (i_{1,1}), spatial basis indicator (i_{1,2}), frequency basis selection window Mᵢₙᵢₜᵢₐₗ, i_{1,5}, frequency basis indicator for layer l (i_{1,6,l}), rotation factor for spatial basis (i_{1,1}), non zero coefficient (NZC) location bitmap for layer l (i_{i,7,l}), strongest NZC location for layer l (i_{i,8,l}), reference amplitude for layer l (i_{2,3,l}), differential amplitude of NZC location for layer l (i_{2,4,l}), phase of NZC for layer l (i_{2,5,l}), port selection (i_{1,2}), frequency basis selection (i_{1,6}), NZC location bit map for layer l (i_{i,7,l}), strongest NZC location for layer l (i_{i,8,l}), reference amplitude for layer l (i_{2,3,l}), differential amplitude of NZC for layer l (i_{2,4,l}) and phase of NZC for layer l (i_{2,5,l}).

To reduce overhead, beam amplitude scaling and cophasing values (e.g., beam combining coefficients) in W₂ can be compressed. Depending on the number of beams, the number of layers, the number of selected spatial basis, the number of selected frequency basis and the number of time/Doppler basis, the number of beam combining coefficients may be very large, e.g., on the order of hundreds or thousands. The weaker beam combining coefficients can be ignored, while only NZC are considered for reporting. However, the number of NZC may also be very large. Thus, this number may be further compressed.

The CSI reporting enhancements for type II codebook introduced herein are related to the reporting of the beam combining coefficients for W₂. In some aspects, the example embodiments describe operations for determining a number of NZC to report. In other aspects, the example embodiments describe operations for phase/amplitude quantization of the NZC to report. In still other aspects, the example embodiments describe operations for prioritizing the NZC to report, e.g., when an UL grant is not large enough to carry all of the NZC.

In some aspects of these example embodiments, the number of NZC that the UE can report in a CSI report can be selected in various ways. For each layer, the total number of beam combining coefficients in W₂ is 2L·M·Q, where L is the number of selected spatial basis per polarization, M is the number of selected frequency basis, and Q is the number of selected time/Doppler basis. From this total number of coefficients, the UE and the network need to be aligned regarding the number that will be included in the CSI report.

According to one aspect, the network can configure the UE via RRC with a maximum number of NZC that the UE can report. Based on the configured maximum number of NZC, the UE can select the number of NZC to report according to the following options. In one option, the UE can select a number of NZC that is less than or equal to the maximum number of NZC configured by the network. In another option, the UE always selects the same number of NZC as the maximum number of NZC configured by the network.

In view of the maximum number of NZC, the network can provide an UL payload size large enough to include all of these NZC. If the UE always selects the same number of NZC as the maximum number, then the size of the CSI report, e.g., number of bits, will remain the same. However, in some cases, the UE can determine based on its channel measurements that an amount of NZC less than the maximum can be reported. For example, some channels have very high correlation in the spatial domain, the frequency domain, and/or the time domain and the NZC reporting for these channels can be highly compressed. If the UE can select the number of NZC as some number less than the maximum, then the size of the CSI report may vary, e.g., based on channel conditions as determined by the UE.

According to another aspect, when the UE can select a number of NZC to report that is smaller than or equal to the maximum number of NZC configured by the network, the UE can further report the number of selected NZC in CSI part 1. Thus, the UE can inform the network of the number of NZC to expect in the CSI report.

According to another aspect, when the network configures the maximum number of NZC, the network can configure the maximum number of NZC per layer. The maximum number of NZC per layer can be configured as a percentage β. The candidate values for the percentage β can be, e.g., 1/8, 1/4, 3/8, 1/2, 5/8, 3/4, or 7/8. For each layer, the total number of coefficients in W₂ is 2L·M·Q, where L is the number of selected spatial basis per polarization, M is the number of selected frequency basis, and Q is the number of selected time/Doppler basis. Thus, the maximum number of NZC that the UE can select per layer is 2L·M·Q·β.

According to another aspect, when the network configures the maximum number of NZC per layer as a percentage β, to further restrict the total number of NZC that the UE can select to limit the size of CSI, the maximum number of NZC across all the layers can be capped as a multiple of the maximum number per layer. For example, this total maximum value can be 2× the per layer maximum value (e.g., R=2). When the UE reports 1 or 2 layers, the second maximum does not come into play and, for each layer, the UE is restricted only from selecting more than 2L·M·Q·β NZC.

When the UE reports more than 2 layers, e.g., 3 or 4 layers, for each layer, the UE is restricted from selecting more than 2L·M·Q·β NZC and, across all the layers with R=2, the UE is restricted from selecting more than 2·2L·M·Q·β NZC. Thus, the reported NZC will need to be reduced to less than 2L·M·Q·β for one or more of the >2 layers to satisfy this second restriction.

In the previously described aspects, the NZC budget is applied irrespective of the type of NZC being reported, e.g., whether the NZC is for the spatial basis, the frequency basis or the time basis. In other aspects to be described below, the NZC budget can be applied across a subset of these basis, e.g., the spatial and frequency basis.

According to another aspect, when the network configures the maximum number of NZC, the network can configure the maximum number of NZC per selected time/Doppler basis per layer. The maximum number of NZC per selected time/Doppler basis per layer can be configured as a percentage, i.e., β. For each layer, for each selected time/Doppler basis, the total number of coefficients in W₂ is 2L·M. The maximum number of NZC that UE can select per layer for each selected time/Doppler basis is 2L·M·β.

According to another aspect, when the network configures the maximum number of NZC per selected time/Doppler basis per layer, the maximum number of NZC across all selected time/Doppler basis per layer can be further restricted by a multiple of the per layer maximum. For example, the maximum number of NZC that UE can select across all selected time/Doppler basis per layer is limited by 2·2L·M·β.

According to another aspect, when the network configures the maximum number of NZC, the network can configure both the maximum number of NZC per selected time/Doppler basis per layer, e.g., as a percentage β₁, and across all selected time/Doppler basis per layer, e.g., as a percentage β₂.

The NZC determined by the UE, e.g., phase and amplitude, comprise complex values. To reduce overhead, differential encoding can be used so that a differential value is reported for these NZC rather than the absolute value. To use differential encoding, a reference NZC is selected and the remaining NZC are reported as differential values relative to the reference NZC.

According to further aspects of these example embodiments, for enhanced Type II codebook to support CSI prediction, to quantize and report the selected NZC (Non-Zero Coefficient), differential encoding/quantization can be used for amplitude and/or phase quantization. Among multiple NZC, one reference NZC is selected. For amplitude quantization, the reference NZC is assumed to have unit amplitude, i.e., 1. For phase quantization, the reference NZC is assumed to have zero phase. For the NZC other than the reference NZC, the UE quantizes and reports the amplitude/phase difference between the corresponding NZC and the reference NZC.

In one aspect, the reference NZC is selected across all layers. In another aspect, when differential encoding/quantization is used for amplitude and/or phase quantization, the differential encoding/quantization is performed per layer. For example, the strongest NZC of each layer is selected as the amplitude/quantization reference of all the other NZC in the same layer.

In another aspect, when differential encoding/quantization is used for amplitude and/or phase quantization, the differential encoding/quantization is performed per selected time/Doppler basis per layer. For example, the strongest NZC of each selected time/Doppler basis of each layer is selected as the amplitude/quantization reference of all the other NZC in the same selected time/Doppler basis of the same layer.

In another aspect, when differential encoding/quantization is used for amplitude quantization, the separate strongest NZC can be selected for different polarization, per layer, or per selected time/Doppler basis per layer. The strongest NZC across both polarizations can be selected for the amplitude/quantization of all the other NZC in the same polarization as the strongest NZC. In the other polarization that does not contain the strongest NZC, among all the NZC in the same polarization, another strongest NZC is selected as the amplitude/quantization of all the other NZC in the same polarization.

For the network to reconstruct the W2 from the reported NZC, the network needs to know the location of the strongest NZC.

In another aspect, when differential encoding/quantization is used for amplitude and/or phase quantization, the following can be used to report the location of the strongest NZC. For the spatial basis index of the strongest NZC, the spatial basis index of the strongest NZC can be flexibly reported. In a first option, the index can be reported as the index of the selected spatial basis. In a second option the index can be reported as the index of the selected spatial basis that contains NZC. For frequency basis of the strongest NZC, in a first option, the strongest NZC is always assumed to be at the lowest frequency basis (Direct Current, DC, basis) without need of explicit reporting. In a second option, the frequency basis index of the strongest NZC can be flexibly reported. For the time/Doppler basis of the strongest NZC, in a first option, the strongest NZC is always assumed to be at the lowest time/Doppler basis without need of explicit reporting. In a second option, the time/Doppler basis index of the strongest NZC can be flexibly reported.

In some instances, the UL payload may be limited and some CSI entries that would be otherwise reported are instead dropped.

According to further aspects of these example embodiments, operations are described for determining the priority of the NZC values.

In one aspect, for enhanced Type II codebook to support CSI prediction, to quantize and report the selected NZC (Non-Zero Coefficient), the NZC are divided into two parts with each part containing roughly the same amount of NZCs. The first part is reported in CSI part 2 group 1, and the second part is reported in CSI part 2 group 2. The report content that needs to be divided includes one or multiple of the following: amplitude quantization; phase quantization; and location of the NZC.

In another aspect, the division is based on the priority of each NZC. Higher priority NZC are assigned to the first part carried by CSI part 2 group 1, while lower priority NZC are assigned to the second part carried by CSI part 2 group 2.

In another aspect, to compute the priority of each NZC, the following options can be used. The terms used in the computation include the following: v is the rank, L is the number of selected spatial basis per polarization, M is the number of selected frequency basis, Q is the number of selected time/Doppler basis; l=0, . . . , v−1 is the layer index; i=0, . . . , 2L−1 is the spatial basis/port index; f=0, . . . , M−1 is the frequency basis index; d=0, . . . , Q−1 is the time/Doppler basis index; π(⋅) is a mapping function, including π(f) for the frequency basis f and π(d) for the time/Doppler basis d, wherein the mapping function is described in greater detail below. In these options, it is noted that a smaller Pri(l, i, f, d) has the higher priority.

In a first option, Pri(l, i, f, d)=2L·M·v·π(d)+2L·v·π(f)+v·i+l. In this option, the layer index is the least important, the spatial basis index is the second least important, the frequency basis index is the second most important, and the time basis index is the most important. In a second option, Pri(l, i, f,d)=2L·Q·v·π(f)+2L·v·π(d)+v·i+l. In this option, the layer index is the least important, the spatial basis index is the second least important, the time basis index is the second most important, and the frequency basis index is the most important. In a third option, Pri(l, i, f, d)=2L·Q·v·π(f)+Q·v·i+π(d)+l. In this option, the layer index is the least important, the time basis index is the second least important, the spatial basis index is the second most important, and the frequency basis index is the most important. In a fourth option, Pri (l, i, f, d)=2L·Q·v·π(f)+Q·v·i+Q·l+π(d). In this option, the time basis index is the least important, the layer index is the second least important, the spatial basis index is the second most important, and the frequency basis index is the most important.

Thus, according to the above options, every NZC is associated with a unique priority value.

In another aspect, for π(f), the following options can be used. In a first option π(f)=f. In a second option,

$$π ( f ) = min ( 2 \cdot {n}_{3}^{( f )} , 2 \cdot ( {N}_{3} - {n}_{3}^{( f )} ) - 1 ) ,$$

where N₃ is the length of the frequency basis; and

$${n}_{3}^{( f )} , {n}_{3}^{( f )} = 0 , 1 , … , {N}_{3} - 1$$

is the frequency basis index for the f^{th} selected frequency basis. In this option, the mapping function π(f) prioritizes the frequency basis index in the following order: {0, N₃−1,1, N₃−2,2, . . . }.

In another aspect, for π(d), the following options can be used. In a first option π(d)=d. In a second option,

$$π ( d ) = min ( 2 \cdot {n}_{4}^{( d )} , 2 \cdot ( {N}_{4} - {n}_{4}^{( d )} ) - 1 ) ,$$

where N₄ is the length of the time/Doppler basis; and

$${n}_{4}^{( d )} , {n}_{4}^{( d )} = 0 , 1 , … , {N}_{4} - 1$$

is the time/Doppler basis index for the d^{th} selected time/Doppler basis. In this option, the mapping function π(d) prioritizes the time/Doppler basis index in the following order: {0, N₄−1,1, N₄−2,2, . . . }.

In another aspect, in case the UE selects Q time/Doppler domain basis, the following can be used. If Q=1, then the legacy Type II codebook division is reused. If Q>1, then: the NZC corresponding to the [Q/2] or [Q/2] selected time/Doppler basis with higher priority is in the first part carried by CSI part 2 group 1; and the NZC corresponding to the [Q/2] or [Q/2] selected time/Doppler basis with lower priority is in the second part carried by CSI part 2 group 2. For each selected time/Doppler basis, the priority can be determined based on π(d) described above, the smaller value has higher priority.

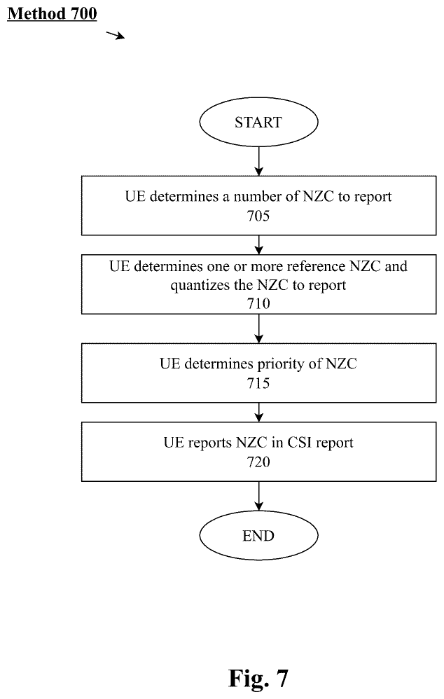

FIG. 7 shows a method 700 for reporting non-zero coefficients (NZC) in W₂ in a CSI report according to various example embodiments.

In 705, the UE determines a number of NZC to report. When the UE is configured for the CSI reporting, the network can configure the UE via RRC with a maximum number of NZC. In some options, the UE can always report the maximum number while, in other options, the UE can report a number less than the maximum. The maximum number can be per layer, across layers, per selected time/Doppler basis per layer, or across all selected time/Doppler basis per layer. In some options, the network can configure the maximum as a percentage of a total number of beam combining coefficients. In some options, multiple maximum values can be configured, e.g., a first maximum per selected time/Doppler basis per layer and a second maximum across all selected time/Doppler basis per layer.

In 710, the UE quantizes the NZCs using differential encoding. A reference NZC is selected and assumed to have unit amplitude and zero phase. The reference NZC can be the strongest NZC. The remaining NZCs other than the reference NZCs can be quantized as a differential value relative to the reference NZC. The differential encoding can be performed per layer or per time/Doppler basis per layer. The differential encoding for amplitude quantization can be performed for different polarizations. The spatial basis index, the frequency basis index, and the time/Doppler basis index of the strongest NZC can be reported in various ways, e.g., flexibly reported by the UE via explicit reporting or, for the frequency and time/Doppler basis, assumed to be the lowest basis without need for explicit reporting.

In 715, the UE determines the priority of the NZC. Higher priority NZC can be assigned to CSI part 2 group 1 and lower priority NZC can be assigned to CSI part 2 group 2. Different types of NZC, e.g., for a particular layer, spatial basis, frequency basis, time/Doppler basis, can be prioritized. If the UL grant is not sufficiently large to carry all the NZC, then the lowest priority NZC can be dropped.

In 720, the UE reports the NZC in the CSI report.

### EXAMPLES

In a first example, a method comprising receiving channel state information (CSI) configuration information for reporting type II codebook based CSI feedback in a CSI report, the CSI configuration information including a maximum number of non-zero coefficients (NZC) in W₂ to include in the CSI report, receiving CSI measurement resources and transmitting the type II codebook CSI feedback to a base station.

In a second example, the method of the first example, further comprising selecting a number of NZC to include in the CSI report based on the maximum number of NZC included in the CSI configuration information.

In a third example, the method of the second example, wherein the UE selects the maximum number of NZC.

In a fourth example, the method of the second example, wherein the UE can select the number of NZC as any number less than or equal to the maximum number of NZC.

In a fifth example, the method of the fourth example, further comprising reporting the number of NZC in part one of the CSI report.

In a sixth example, the method of the first example, wherein a total number of coefficients in W₂ is equal to 2L·M·Q per layer, wherein L is a number of selected spatial basis per polarization, M is a number of selected frequency basis and Q is a number of selected time basis.

In a seventh example, the method of the sixth example, wherein the maximum number of NZC to include in the CSI report is configured as a percentage β per layer.

In an eighth example, the method of the seventh example, wherein candidate values for the percentage β include 1/8, 1/4, 3/8, 1/2, 5/8, 3/4, and 7/8.

In a ninth example, the method of the seventh example, wherein the maximum number of NZC to include in the CSI report is further configured as a further maximum number of NZC across all layers.

In a tenth example, the method of the ninth example, wherein the further maximum number of NZC across all layers is a multiple of the maximum number of NZC per layer.

In an eleventh example, the method of the sixth example, wherein the maximum number of NZC to include in the CSI report is configured as a percentage β per layer for each selected time basis.

In a twelfth example, the method of the eleventh example, wherein the maximum number of NZC to include in the CSI report is further configured as a further maximum number of NZC across all selected time basis.

In a thirteenth example, the method of the sixth example, wherein the maximum number of NZC to include in the CSI report is configured as a percentage β₁ per layer for each selected time basis and a further maximum number of NZC is configured as a percentage β₂ across all selected time basis per layer.

In a fourteenth example, a processor configured to perform any of the methods of the first through thirteenth examples.

In a fifteenth example, a user equipment (UE) comprising a transceiver configured to communicate with a network and a processor communicatively coupled to the transceiver and configured to perform any of the methods of the first through thirteenth examples.

In a sixteenth example, a method comprising receiving channel state information (CSI) configuration information for reporting type II codebook based CSI feedback in a CSI report, receiving CSI measurement resources, selecting, from among multiple non-zero coefficients (NZC) in W₂, a reference NZC, quantizing the NZC and transmitting the type II codebook CSI feedback to a base station.

In a seventeenth example, the method of the sixteenth example, wherein the reference NZC is assumed to have unit amplitude and, for each NZC other than the reference NZC, an amplitude difference is determined between the NZC and the reference NZC.

In an eighteenth example, the method of the sixteenth example, wherein the reference NZC is assumed to have zero phase and, for each NZC other than the reference NZC, a phase difference is determined between the NZC and the reference NZC.

In a nineteenth example, the method of the sixteenth example, wherein the reference NZC is a strongest NZC.

In a twentieth example, the method of the nineteenth example, wherein a separate reference NZC is selected per layer.

In a twenty first example, the method of the nineteenth example, wherein a separate reference NZC is selected per selected time basis per layer.

In a twenty second example, the method of the nineteenth example, wherein a separate reference NZC is selected for different polarizations.

In a twenty third example, the method of the twenty second example, wherein a strongest NZC is selected across both polarizations for quantizing all other NZC in a same polarization and, in the other polarization that does not contain the strongest NZC, selecting a further strongest NZC among all NZC in the other polarization.

In a twenty fourth example, the method of the sixteenth example, wherein a spatial basis index of a strongest NZC is flexibly reported as an index of a selected spatial basis.

In a twenty fifth example, the method of the sixteenth example, wherein a spatial basis index of a strongest NZC is flexibly reported as an index of a selected spatial basis that contains NZC.

In a twenty sixth example, the method of the sixteenth example, wherein a frequency basis index of a strongest NZC is considered to be at a lowest frequency basis.

In a twenty seventh example, the method of the sixteenth example, wherein a frequency basis index of a strongest NZC is flexibly reported.

In a twenty eighth example, the method of the sixteenth example, wherein a time basis index of a strongest NZC is considered to be at a lowest time basis.

In a twenty ninth example, the method of the sixteenth example, wherein a time basis index of a strongest NZC is flexibly reported.

In a thirtieth example, a processor configured to perform any of the methods of the sixteenth through twenty ninth examples.

In a thirty first example, a user equipment (UE) comprising a transceiver configured to communicate with a network and a processor communicatively coupled to the transceiver and configured to perform any of the methods of the sixteenth through twenty ninth examples.

In a thirty second example, a method comprising receiving channel state information (CSI) configuration information for reporting type II codebook based CSI feedback in a CSI report, receiving CSI measurement resources, determining a priority for multiple non-zero coefficients (NZC) in W₂ to include in the CSI report and transmitting the type II codebook CSI feedback to a base station.

In a thirty third example, the method of the thirty second example, wherein the multiple NZC are divided into a first part and a second part, the first part being reported in CSI part 2 group 1 and the second part being reported in CSI part 2 group 2.

In a thirty fourth example, the method of the thirty third example, wherein higher priority NZC are assigned to the first part and lower priority NZC are assigned to the second part.

In a thirty fifth example, the method of the thirty second example, wherein the priority for a NZC is computed by an equation including a layer index for the NZC, a spatial basis index for the NZC, a frequency basis index for the NZC, and a time basis index for the NZC.

In a thirty sixth example, the method of the thirty fifth example, wherein, in the equation, the layer index is given a lowest weight, the spatial basis index is given a second lowest weight, the frequency basis index is given a second highest weight, and the time basis index is given a highest weight.

In a thirty seventh example, the method of the thirty fifth example, wherein, in the equation, the layer index is given a lowest weight, the spatial basis index is given a second lowest weight, the time basis index is given a second highest weight, and the frequency basis index is given a highest weight.

In a thirty eighth example, the method of the thirty fifth example, wherein, in the equation, the layer index is given a lowest weight, the time basis index is given a second lowest weight, the spatial basis index is given a second highest weight, and the frequency basis index is given a highest weight.

In a thirty ninth example, the method of the thirty fifth example, wherein, in the equation, the time basis index is given a lowest weight, the layer index is given a second lowest weight, the spatial basis index is given a second highest weight, and the frequency basis index is given a highest weight.

In a fortieth example, the method of the thirty fifth example, wherein the frequency basis index is prioritized by a mapping function defined as

$$min ( 2 \cdot {n}_{3}^{( f )} , 2 \cdot ( {N}_{3} - {n}_{3}^{( f )} ) - 1 ) ,$$

where N₃ is a length of the frequency basis and

$${n}_{3}^{( f )} , {n}_{3}^{( f )} = 0 , 1 , … , {N}_{3} - 1$$

is the frequency basis index for the f^{th} selected frequency basis.

In a forty first example, the method of the thirty fifth example, wherein the time basis index is prioritized by a mapping function defined as

$$min ( 2 \cdot {n}_{4}^{( d )} , 2 \cdot ( {N}_{4} - {n}_{4}^{( d )} ) - 1 ) ,$$

where N₄ is a length of the time basis and

$${n}_{4}^{( d )} , {n}_{4}^{( d )} = 0 , 1 , … , {N}_{4} - 1$$

is the time basis index for the d^{th} selected time basis.

In a forty second example, the method of the thirty second example, wherein, if the UE selects 1 time basis, a legacy type-II codebook division is reused.

In a forty third example, the method of the thirty second example, wherein, if the UE selects greater than 1 time basis, NZC corresponding to [Q/2] or [Q/2] selected time basis with higher priority is in the first part carried by CSI part 2 group 1 and NZC corresponding to the [Q/2] or [Q/2] selected time basis with lower priority is in the second part carried by CSI part 2 group 2.

In a forty fourth example, a processor configured to perform any of the methods of the thirty second through forty third examples.

In a forty fifth example, a user equipment (UE) comprising a transceiver configured to communicate with a network and a processor communicatively coupled to the transceiver and configured to perform any of the methods of the thirty second through forty third examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry configured to:
process, based on signals received from a base station, channel state information (CSI) configuration information for reporting type II codebook based CSI feedback in a CSI report, the CSI configuration information including a maximum number of non-zero coefficients (NZC) in W₂ to include in the CSI report;
process, based on signals received from the base station, a message comprising CSI measurement resources; and
generate, for transmission to the base station, the type II codebook CSI feedback.

2. The apparatus of claim 1, wherein the processing circuitry is further configured to:
select a number of NZC to include in the CSI report based on the maximum number of NZC included in the CSI configuration information.

3. The apparatus of claim 2, wherein the UE can select the number of NZC as any number less than or equal to the maximum number of NZC.

4. The apparatus of claim 3, wherein the processing circuitry is further configured to:
generate, for reporting to the base station, a message comprising the number of NZC in part one of the CSI report.

5. The apparatus of claim 1, wherein a total number of coefficients in W₂ is equal to 2L·M·Q per layer, wherein L is a number of selected spatial basis per polarization, M is a number of selected frequency basis and Q is a number of selected time basis.

6. The apparatus of claim 5, wherein the maximum number of NZC to include in the CSI report is configured as a percentage β per layer.

7. The apparatus of claim 6, wherein candidate values for the percentage β include 1/8, 1/4, 3/8, 1/2, 5/8, 3/4, and 7/8.

8. The apparatus of claim 6, wherein the maximum number of NZC to include in the CSI report is further configured as a further maximum number of NZC across all layers.

9. The apparatus of claim 8, wherein the further maximum number of NZC across all layers is a multiple of the maximum number of NZC per layer.

10. An apparatus comprising processing circuitry configured to:
process, based on signals received from a base station, channel state information (CSI) configuration information for reporting type II codebook based CSI feedback in a CSI report;
process, based on signals received from the base station, a message comprising CSI measurement resources;
determine a priority for multiple non-zero coefficients (NZC) in W₂ to include in the CSI report; and
generate, for transmission to the base station, the type II codebook CSI feedback.

11. The apparatus of claim 10, wherein the multiple NZC are divided into a first part and a second part, the first part being reported in CSI part 2 group 1 and the second part being reported in CSI part 2 group 2.

12. The apparatus of claim 10, wherein the priority for a NZC is computed by an equation including a layer index for the NZC, a spatial basis index for the NZC, a frequency basis index for the NZC, and a time basis index for the NZC.

13. The apparatus of claim 12, wherein, in the equation, the layer index is given a lowest weight, the spatial basis index is given a second lowest weight, the frequency basis index is given a second highest weight, and the time basis index is given a highest weight.

14. The apparatus of claim 12, wherein, in the equation, the layer index is given a lowest weight, the spatial basis index is given a second lowest weight, the time basis index is given a second highest weight, and the frequency basis index is given a highest weight.

15. The apparatus of claim 12, wherein, in the equation, the layer index is given a lowest weight, the time basis index is given a second lowest weight, the spatial basis index is given a second highest weight, and the frequency basis index is given a highest weight.

16. The apparatus of claim 12, wherein, in the equation, the time basis index is given a lowest weight, the layer index is given a second lowest weight, the spatial basis index is given a second highest weight, and the frequency basis index is given a highest weight.

17. The apparatus of claim 12, wherein the frequency basis index is prioritized by a mapping function defined as
$$min ( 2 \cdot {n}_{3}^{( d )} , 2 \cdot ( {N}_{3} - {n}_{3}^{( d )} ) - 1 ) ,$$
where N₃ is a length of the frequency basis and
$${n}_{3}^{( f )} , {n}_{3}^{( f )} = 0 , 1 , … , {N}_{3} - 1$$
is the frequency basis index for the f^{th} selected frequency basis.

18. The apparatus of claim 12, wherein the time basis index is prioritized by a mapping function defined as
$$min ( 2 \cdot {n}_{4}^{( d )} , 2 \cdot ( {N}_{4} - {n}_{4}^{( d )} ) - 1 ) ,$$
where N₄ is a length of the time basis and
$${n}_{4}^{( d )} , {n}_{4}^{( d )} = 0 , 1 , … , {N}_{4} - 1$$
is the time basis index for the d^{th} selected time basis.

19. The apparatus of claim 10, wherein, if the UE selects 1 time basis, a legacy type-II codebook division is reused.

20. The apparatus of claim 10, wherein, if the UE selects greater than 1 time basis, NZC corresponding to [Q/2] or [Q/2] selected time basis with higher priority is in the first part carried by CSI part 2 group 1 and NZC corresponding to the [Q/2] or [Q/2] selected time basis with lower priority is in the second part carried by CSI part 2 group 2.
